(19) United States
(12) Patent Application Publication
(10) Pub. No.: US 2013/0264872 A1
(43) Pub. Date: Oct. 10, 2013

(54) POWER CONVERSION APPARATUS INCLUDING A PLURALITY OF POWER CONVERSION CIRCUITS AND FILTER CIRCUIT SHARED THEREBY

(71) Applicant: DENSO CORPORATION, Kariya-city (JP)

(72) Inventors: Masakazu TAGO, Aisai-shi (JP); Atsuyuki HIRUMA, Kariya-shi (JP)

(73) Assignee: DENSO CORPORATION, Kariya-city (JP)

(21) Appl. No.: 13/857,354

(22) Filed: Apr. 5, 2013

(30) Foreign Application Priority Data
Apr. 6, 2012 (JP) 2012-087844

(51) Int. Cl. H02P 27/06

(52) U.S. Cl. CPC H02P 27/06
USPC 307/31

(57) ABSTRACT

A power conversion apparatus includes a filter circuit, a power conversion circuit, a first casing and a second casing. An input circuit of the filter circuit is connected to a power source to receive power from the power source. A plurality of power conversion circuits are disposed correspondingly to the electrical loads in which every input circuit of the power conversion circuits is connected to an output circuit of the filter circuit and respective output circuits of the power conversion circuits are correspondingly connected to the electrical loads. The power conversion circuit converts the power from the filter circuit and supplies the converted power to the electrical loads. The first casing accommodates the filter circuit and plural second casings are disposed correspondingly to the plurality of power conversion circuits. Each of the second casings accommodates corresponding power conversion circuit.

### CROSS REFERENCE TO RELATED APPLICATION

This application is based on and claims the benefit of priority from earlier Japanese Patent Application No. 2012-87844 filed on Apr. 6, 2012 the description of which is incorporated herein by reference.

### BACKGROUND

1. Technical Field

The present disclosure relates to a power conversion apparatus that converts power to be supplied to the electrical load.

2. Description of the Related Art

Conventionally, power conversion apparatuses are used for various electrical loads such as motors in which the motors are driven by the power converted by the power conversion apparatus. In particular, a power conversion apparatus provided with a plurality of power conversion circuits corresponding to a plurality of motors to be driven by the power conversion circuits has been known. For example, Japanese Patent Application Laid-Open Publication No. 2002-345252 discloses a power conversion apparatus in which power conversion circuits are arranged closely to the respective motors whereby the wiring length connecting between the power conversion circuit and the motor is shortened.

However, in the power conversion apparatus according to the above described patent application, depending on types of vehicles to which the power conversion apparatus is mounted, all power conversion apparatuses cannot be disposed closely to the motors because of limited space available in the vehicle. When the power conversion apparatus cannot be disposed closely to the motor, since the wiring length between the power conversion apparatus and the motor becomes longer, the inductance of the wiring becomes larger. Therefore, it is likely to trigger an abnormal surge voltage in the power conversion apparatus due to increasing inductance value. The above-described patent document suggests that LC filters may be used to avoid occurrence of an abnormal surge voltage, however, the specific location of the LC filter to be disposed in the circuit is not clearly described.

Generally, the filter circuit such as a LC filter is disposed at an input side of the power conversion apparatus. For instance, in the power conversion apparatus according to the above-described patent document, each of the filter circuits is disposed at the respective input sides of the power conversion circuits. However, according to the configuration using a plurality of filter circuits corresponding to a plurality of power conversion circuits, there is a concern that size of the whole apparatus may significantly increase.

### SUMMARY

The embodiment of the present disclosure provides a power conversion apparatus having small size body and high flexibility of the layout design.

Specifically, the embodiment provides a power conversion apparatus that converts power transmitted from a power source and supplies a plurality of electrical loads with power converted by the power conversion apparatus. The power conversion apparatus includes a filter circuit, a power conversion circuit, a first casing and a second casing. The filter circuit includes an input circuit and an output circuit, in which the input circuit is connected to the power source to receive power from the power source and a filtered power is outputted via the output circuit. Regarding the power conversion circuit, a plurality of power conversion circuits are disposed correspondingly to the plurality of electrical loads in which every input circuit of the power conversion circuits is electrically connected to the output circuit of the filter circuit and respective output circuits are correspondingly connected to the plurality of electrical loads. The power conversion circuit converts the power transmitted from the filter circuit and supplies the power converted by the power conversion circuit to corresponding electrical loads. The first casing accommodates the filter circuit and plural second casings are disposed correspondingly to the plurality of power conversion circuits. Each of the second casings accommodates corresponding power conversion circuit.

Thus, according to the present disclosure, the filter circuit is connected in common to the input sides (i.e., input circuits) of the plurality of power conversion circuits, that is, the filter circuit is shared by the plurality of power conversion circuits. Therefore, comparing to a configuration in which a plurality of filter circuits are disposed correspondingly to the respective power conversion circuits, the size of the whole power conversion apparatus of the present disclosure can be significantly shrunk.

Moreover, the filter circuit is accommodated in the first casing and the respective power conversion circuits are accommodated in the second casing so that flexibility of layout design for the first and second casings can be increased. As a result, since the respective components that constitute the power conversion apparatus can be disposed at any locations, the mountability can be improved. For example, assuming the respective second casings that accommodate the power conversion circuits are disposed closely to corresponding electrical loads, the length of the lead wiring between the power conversion circuit and the electrical load is shortened so that inductance value can be smaller, whereby abnormal surge voltage can be suppressed. Moreover, according to the present disclosure, the filter circuit is accommodated in the first casing and the power conversion circuit is accommodated in the second casing. Therefore, the filter circuit and the power conversion circuit can be protected against suffering from external shock, heat, liquid such as water and foreign materials having conductivity.

Further, since the first and second casings are made of material capable of shielding electromagnetic waves, such as metal, electromagnetic noise entering to the filter circuit and the power conversion circuits from outside the casing can be suppressed and electromagnetic waves radiating outside the casing from the filter circuit and the power conversion circuits can be suppressed as well. When the first casing and the second casing are made of material having high thermal conductivity such as metal, heat generated in the casing can be promptly radiated outside the casing.

Considering a common filter circuit is connected to input sides of a plurality of power conversion circuits as similar to the configuration disclosed in the present disclosure, ripple current is more likely to increase when the switching timings (ON-OFF timings of switching elements) of the power conversion circuits are substantially the same. Accordingly, since the larger the ripple current, the larger the size of the filter circuit, size of the power conversion apparatus may become larger. In this respect, the power conversion apparatus according to the present disclosure is provided with a control unit. The control unit transmits an operation signal that controls the switching timings of the switching elements to be different from each other, whereby the ripple current flowing through the filter circuit can be reduced.

### BRIEF DESCRIPTION OF THE DRAWINGS

In the accompanying drawings:

FIG. 1 is a block diagram showing a power conversion apparatus according to the first embodiment of the present disclosure;

FIGS. 2A, 2B, 2C, 2D and 2E are explanatory diagrams showing operation of the power conversion apparatus according to the first embodiment, wherein FIG. 2A is a diagram showing a carrier signal, FIGS. 2B, 2C, 2D are diagrams showing ripple current that flow through each of the power conversion circuits and FIG. 2E is a diagram showing ripple current that flows thorough a filter circuit;

FIGS. 3A, 3B, 3C, 3D and 3E are explanatory diagrams showing operation of the power conversion apparatus based on a comparative example, wherein FIG. 3A is a diagram showing a carrier signal, FIGS. 3B, 3C and 3D are diagrams showing ripple current that flow through each of the power conversion circuits and FIG. 3E is a diagram showing ripple current that flows through a filter circuit;

FIGS. 4A, 4B, 4C, 4D and 4E are explanatory diagrams showing operation of the power conversion apparatus according to the fourth embodiment, wherein FIG. 4A is a diagram showing a carrier signal, FIGS. 4B, 4C, 4D are diagrams showing ripple current that flow through each of the power conversion circuits and FIG. 4E is a diagram showing ripple current that flows thorough a filter circuit;

FIG. 5 is a block diagram showing a power conversion apparatus according to the fifth embodiment;

FIG. 6 is a block diagram showing a power conversion apparatus according to the fifth embodiment; and

FIG. 7 is a block diagram showing a power conversion apparatus according to the fifth embodiment.

### DETAILED DESCRIPTION OF THE PREFERRED EMBODIMENTS

With reference to the drawings, power conversion apparatuses based on several embodiments of the present disclosure are described as follows. It is noted that substantially the same configurations in the embodiments are labeled with an identical reference numbers and redundant explanation thereof is omitted.

### First Embodiment

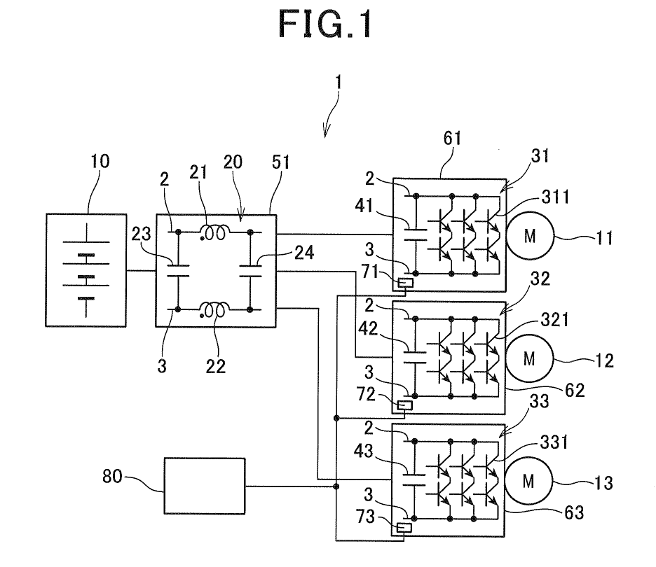

The power conversion apparatus according to the first embodiment is as shown in FIG. 1.

The power conversion apparatus 1 converts the power transmitted from the battery 10 as a power source and supplies the power converted by the power conversion apparatus 1 to electrical loads such as motors 11, 12 and 13. The battery 10, the motors 11, 12 and 13 are mounted on the vehicle. The battery 10 is a high voltage power source such as secondary batteries including a lithium-ion battery or a nickel-metal hydride battery of which terminal voltage exceeds 100 volts. The battery 10 is used for a power source of a motor generator (not shown) serving as a traction motor mounted on the vehicle. The rotary shaft of the motor generator is mechanically connected to the driving wheel of the vehicle.

The motor 11 is a motor of a blower fan used for on-vehicle air-conditioner as an auxiliary unit in the vehicle. The motor 12 is a motor used for, for example, a water pump that circulates cooling water of the internal combustion engine mounted on the vehicle. The motor 13 is a motor used for, for example, a cooling fan that cools the on-vehicle radiator. The motor 11, 12 and 13 are brushless motor which are driven by a three-phase AC (alternating current) voltage.

The power conversion apparatus 1 is provided with a filter circuit 20, power conversion circuits 31, 32 and 33, the first casing 51, the second casings 61, 62, and 63, and control circuit 71, 72 and 73. The power conversion apparatus 1 is mounted on the vehicle together with the battery 10, motors 11, 12 and 13. The filter circuit 20 includes coils 21 and 22, capacitors 23 and 24. The coil 21 is disposed at an upper main line 2 connected to the positive terminal of the battery 10. The coil 22 is disposed at a lower main line 3 connected to the negative terminal of the battery 10. The capacitor 23 is connected between the one end of the coil 21 and the one end of the coil 22. The capacitor 24 is disposed to connect the other end of the coil 21 and the other end of the coil 22. According to this circuit configuration, the filter circuit 20 serves as an LC filter and is capable of smoothing the current flowing through the upper main line 2 and the lower main line 3. The one end of the coil 21 and the one end of the cold 22 correspond to the input circuit of the filter circuit. The other end of the coil 21 and the other end of the coil 22 correspond to the output circuit of the filter circuit.

The power conversion circuit 31 includes a plurality of switching elements 311. According to the first embodiment, the switching element 311 is a semiconductor device capable of switching such as IGBT (insulated gate bipolar transistor) and configured by six switching elements. Three switching elements among the six switching elements 311 are connected to the upper main line 2 which is connected to the output side of the filter circuit 20 so as to constitute an upper arm. The remaining three switching elements each connects a corresponding switching element in the upper arm with the lower main line connected to the output side of the filter circuit 20 so as to constitute the lower arm. The respective connection points between the upper arm and the lower arm are connected to the respective phase-windings of the motor 11. The connection points between switching elements 311 and the upper main line 2 or the lower main line 3 correspond to an input circuit of the power conversion circuit. The connection points between the respective upper arm and the respective lower arm correspond to an output circuit of the power conversion apparatus. The power conversion circuit 31 converts the power transmitted from the battery 10 via the filter circuit 20 such that the control circuit 71 (described later) controls the switching element 311 to be ON and OFF so as to convert the power, and outputs the converted power to the motor 11.

The power conversion circuit 32 includes a plurality of switching elements 321. The power conversion circuit 33 includes a plurality of switching elements 331. Since the configuration of the power conversion circuits 32 and 33 are identical with that of the power conversion circuit 31, an explanation of the detail configuration thereof is omitted. The power conversion circuit 32 converts the power transmitted from the battery 10 via the filter circuit 20 such that the control circuit 72 (described later) controls the switching element 321 to be ON and OFF so as to convert the power, and outputs the converted power to the motor 12. Similarly, the power conversion circuit 33 converts the power transmitted from the battery 10 via the filter circuit 20 such that the control circuit 73 (described later) controls the switching element 331 to be ON and OFF so as to convert the power, and outputs the converted power to the motor 13.

As described above, in the first embodiment, all input sides of the power conversion circuits 31, 32 and 33 are connected to the output side of the filter circuit 20. According to this circuit configuration, the filter circuit 20 can suppress ripple current generated when the power conversion circuits 31, 32 and 33 operate. It is noted that a capacitor 41 is disposed at the filter circuit 20 side of the power conversion circuit 31 to be connected between the upper main line 2 and the lower main line 3. Also, a capacitor 42 is disposed at the filter circuit 20 side of the power conversion circuit 32 to be connected between the upper main line 2 and the lower main line 3, and a capacitor 43 is disposed at the filter circuit 20 side of the power conversion circuit 33 to be connected between the upper main line 2 and the lower main line 3. The capacitors 41, 42 and 43 are capable of smoothing current flowing through the upper main line 2 and the lower main line 3.

The first casing 51 is made of metal such as aluminum to form a box shape and accommodates the filter circuit 20. According to the first embodiment, the first casing 51 is disposed in the casing of a DC-DC converter (not shown) that converts the voltage of the power transmitted from the battery 10 to be stepped down and supplies the control circuits 71, 72 and 73. The second casings 61, 62 and 63 are made of metal such as aluminum to form a box shape and the second casings 61, 62 and 63 accommodate the power conversion circuits 31, 32 and 33 respectively. According to the first embodiment, the second casing 61 is mounted on a motor casing that forms the outline of the motor 11. Similarly, the second casings 62 and 63 are mounted on the motor casing of the motor 12 and the motor casing of the motor 13 respectively.

The control circuit 71 is accommodated in the second casing 61 together with the power conversion circuit 31. The control circuit 71 and the power conversion circuit 31 are electrically connected. The control circuit 71 transmits an operation signal to the power conversion circuit 31, thereby controlling the operation of the power conversion circuit 31. Specifically, the control circuit 71 transmits the operation signal to the switching element 311, thereby controlling the switching element 311 to be ON and OFF. By controlling the switching element 311 to be ON and OFF, the control circuit 71 converts the power transmitted from the battery 10 to be three-phase AC voltage, and supplies the motor 11 with the three-phase AC voltage.

More specifically, the control circuit 71 responds to a command value sent from the electronic control unit (hereinafter referred to ECU) 80 so as to control the command voltage to be applied to the motor 11 by performing the triangle-wave PWM (pulse width modulation) processing. That is, a three-phase command voltage is normalized with an input voltage of the switching element 311 to generate a duty signal, and the control circuit 71 compares an amount of the duty signal and a carrier signal (triangle wave shape) so as to generate a PWM signal. Then, the control circuit 71 executes a dead time processing based on the PWM signal and its inverted signal so as to generate the operation signal.

The control circuit 72 is accommodated in the second casing 62 together with the power conversion circuit 32. The control circuit 72 and the power conversion circuit 32 are electrically connected. The control circuit 72 transmits the operation signal to the power conversion circuit 32 thereby controlling the operation of the power conversion circuit 32. Specifically, the control circuit 72 transmits the operation signal to the switching element 321, thereby controlling the switching element 321 to be ON and OFF. By controlling the switching element 321 to be ON and OFF, the control circuit 72 converts the power transmitted from the battery 10 to be three-phase AC voltage, and supplies the motor 12 with the three-phase AC voltage. As similar to the control circuit 71, the control circuit 72 responds to the command value sent from the ECU 80 so as to control the command voltage to be applied to the motor 12 by performing the triangle-wave PWM (pulse width modulation) processing.

The control circuit 73 is accommodated in the second casing 63 together with the power conversion circuit 33. The control circuit 73 and the power conversion circuit 33 are electrically connected. The control circuit 73 transmits the operation signal to the power conversion circuit 33 thereby controlling the operation of the power conversion circuit 33. Specifically, the control circuit 73 transmits the operation signal to the switching element 331, thereby controlling the switching element 331 to be ON and OFF. By controlling the switching element 331 to be ON and OFF, the control circuit 73 converts the power transmitted from the battery 10 to be three-phase AC voltage, and supplies the motor 13 with the three-phase AC voltage. As similar to the control circuits 71 and 72, the control circuit 73 responds to the command value sent from the ECU 80 so as to control the command voltage to be applied to the motor 13 by performing the triangle-wave PWM (pulse width modulation) processing.

The ECU 80 calculates the command value based on commands such as rotational speed command sent from an external unit and transmits the calculated command value to the control circuits 71, 72 and 73. Each of the control circuits 71, 72 and 73 generates an operation signal based on the command value sent from the ECU 8 and transmits the operation signal to the switching elements 311, 321 and 331. The control circuits 71, 72, 73 and ECU 30 correspond to the control unit. It is noted that the control circuits 71, 72 and 73 operates with power from the DC-DC converter (not shown) that converts the power from the battery 10 to be stepped down. Meanwhile, the ECU 80 operates with a power supplied by the other low voltage power source.

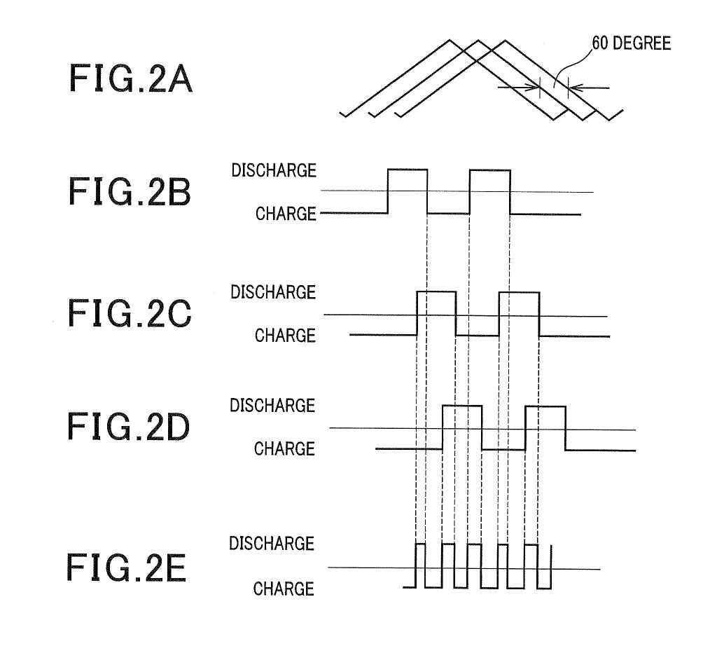

Next, an operation of the power conversion apparatus 1 according to the first embodiment is described with reference to FIGS. 2A, 2B, 2C, 2D and 2E. According to the first embodiment, the power conversion apparatus 1 converts the power based on a three phase modulation. The power conversion apparatus 1 controls the phases of the carrier signals of the power conversion circuits 31, 32 and 33 to be shifted each other. Specifically, the ECU 80, the control circuits 71, 72 and 73 control the switching elements included in the power conversion circuits 31, 32 and 33 based on the carrier signals of which phases are shifted from each other by a predetermined phase angle, e.g. 60 degree, (FIG. 2A) such that the respective switching elements are controlled to be ON and OFF with different timings from each other.

An amount of the phase-shift is expressed as: 1/(2×Fc×Na), where Fc is a carrier frequency, and Na is the number of power conversion circuits. According to the first embodiment, since the number Na of power conversion circuits is 3, the amount of the phase-shift becomes 1/(6×Fc). When the phase is represented by the angle, assuming the carrier period (equivalent to 1/Fc) is 360 degree, the amount of the phase-shift angle is 360×(⅙)=60 degree. In this case, the phase-shift angle includes angles multiplied by 60 degree (excludes 180 degree and its multiplied angles).

According to the first embodiment, as described above, the power conversion circuits 31, 32 and 33 operates with the switching elements 311, 321, 331 turning ON and OFF with different switching timing from each other. The ripple current flowing through the power conversion circuits 31, 32 and 33 are illustrated in FIGS. 2B, 2C and 2D respectively. Accordingly, the ripple current flowing through the filter circuit 20 (total ripple current) is shown in FIG. 2E.

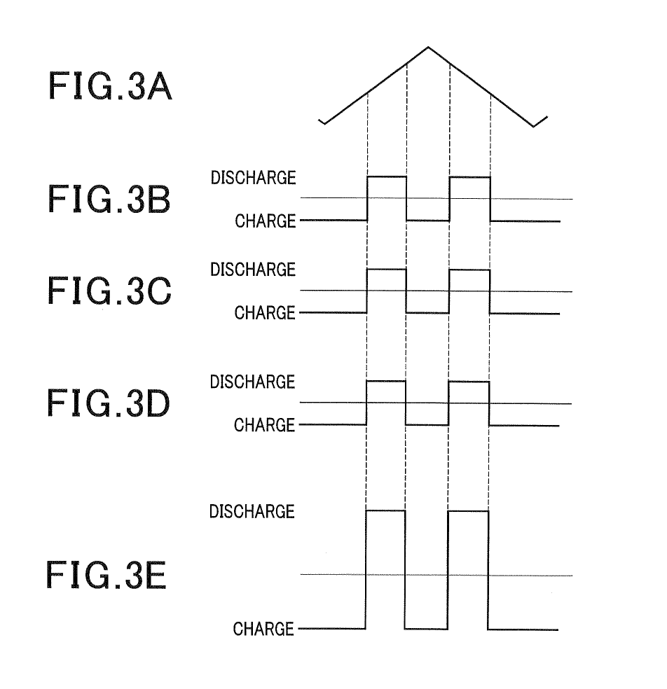

Next, with reference to a comparative example, the operation of the power conversion apparatus and advantage thereof is described as follows. The configuration of the power conversion apparatus in the comparative example is similar to that of the first embodiment, however, control of the power conversion circuits 31, 32 and 33 is different from that of the first embodiment. In the comparative example, the power conversion apparatus controls the carrier signal of the power conversion circuits 31, 32 and 33 to be synchronized with the same phase angle. In other words, as shown in FIG. 3A, the ECU 80, the control circuits 71, 72 and 73 control the power conversion circuits 31, 32 and 33 to be ON or OFF at the same timing based on the carrier signal, whereby the carrier signals are synchronized at the same phase angle.

According to the comparative example, as described above, the power conversion circuits 31, 32 and 33 operates with the switching elements 311, 321 and 331 turning ON or OFF simultaneously. As a result, the ripple current flowing through the power conversion circuits 31, 32 and 33 is as shown in FIGS. 3B, 3C and 3D. The ripple current flowing through the filter circuit 20 (total ripple current) is as shown in FIG. 3E. When comparing the ripple current as shown in FIG. 2E with the ripple current as shown in FIG. 3E, it is understand that an amount of ripple current (total ripple current) flowing through the filter circuit 20 according to the first embodiment is significantly reduced compared to the comparative example. Thus, according to the first embodiment, a maximum value of the total ripple current capable of flowing through the filter circuit 20 is smaller than that of the comparative example. Hence, the size of the filter circuit 20 can be shrunk.

(1) As described above, according to the first embodiment, a configuration in which a common filter circuit 20 is connected to the input sides of the power conversion circuits 31, 32 and 33 is employed, whereby the size of the power conversion apparatus can be shrunk. Moreover, according to the first embodiment, the filter circuit 20 is accommodated in the first casing 51 and the power conversion circuits 31, 32 and 33 are accommodated in the second casings 61, 62 and 63 respectively. Therefore, flexibility of layout design for the first casing 51 and the second casings 31, 32 and 33 is high so that each component that constitutes the power conversion apparatus 1 can be distributed at any location in the power conversion apparatus 1. For example, the second casings 61, 62 and 63 that accommodate the power conversion circuits 31, 32 and 33 are disposed at corresponding motor casings 11, 12 and 13. Hence, length of the respective lead wires between the power conversion circuit 31, 32 and 33, and the motors 11, 12 and 13 become short so that the inductance values thereof become smaller. As a result, occurrence of an abnormal surge voltage can be suppressed.

According to the first embodiment, since the filter circuit 20 is accommodated in the first casing 51 and the power conversion circuit 31, 32 and 33 are accommodated in the second casings 61, 62 and 63, the filter circuit 20 and the power conversion circuits 31, 32 and 33 can avoid suffering from external shock, heat, liquid such as water and foreign materials having conductivity. According to the first embodiment, the first casing 51 and the second casings 61, 62 and 63 are made of metal such as aluminum that is capable of shielding electromagnetic waves so that electromagnetic waves entering to the filter circuit 20 and power conversion circuits 31, 32 and 33 from outside the casing can be suppressed. Also, electromagnetic waves radiating outside the casing from the filter circuit 20 and the power conversion circuit 31, 32 and 33 can be suppressed. Moreover, according to the first embodiment, the first casing 51 and the second casings 61, 62 and 63 are made of metal such as aluminum having relatively higher thermal conductivity. Therefore, heat generated in the casing can be promptly radiated to outside the casing.

According to the first embodiment, considering the common filter circuit 20 is connected to the input sides of the power conversion circuits 31, 32 and 33, there is a concern that the ripple current flowing through the filter circuit 20 may increase when the switching timings (i.e., ON and OFF timing) of the power conversion circuits 31, 32 and 33 are the same. As a result, it is necessary to use a large size of filter circuit 20 to allow large ripple current to flow through the filter circuit 20, whereby the whole power conversion apparatus may become larger.

(2) Hence, in the first embodiment, the power conversion apparatus includes the control circuits 71, 72 and 73 and the ECU 80, wherein the ECU 80 and the control circuits 71, 72 and 73 transmit the operation signal to the power conversion circuits 31, 32 and 33 thereby controlling the operation of the power conversion circuits 31, 32 and 33. Specifically, the ECU 80 and the control circuits 71, 72 and 73 generate an operation signal that controls the switching elements in the power conversion circuits 31, 32 and 33 to be ON and OFF with different timings from each other and transmit the operation signal to the power conversion circuits 31, 32 and 33. As a result, since an amount of ripple current flowing through the filter circuit 20 can be smaller, the size of the filter circuit 20 can be designed to be smaller so that the size of the power conversion apparatus can be smaller as well.

(3) According to the first embodiment, the operation signal includes a carrier frequency that is synchronized to the clock frequency of the control circuit 71, 72 and 73, and the ECU 80. The control circuit 71, 72 and 73, and the ECU 80 control the phase of the carrier signals to be shifted from each other to have the power conversion circuits 31, 32 and 33 operate with different switching timings. As a result, an amount of the ripple current flowing through the filter circuit 20 can be reduced.

### Second Embodiment

The power conversion apparatus according to the second embodiment is described as follows. In the second embodiment, the power conversion apparatus performs a three phase modulation as similar to the first embodiment. The power conversion apparatus controls the respective power conversion circuits 31, 32 and 33 to have different carrier frequencies from each other. In other words, the ECU 80 and the control circuits 71, 72 and 73 transmit carrier signals corresponding to the power conversion circuits 31, 32 and 33 in which the carrier frequencies of the carrier signals are set to be different from each other to the power conversion circuits 31, 32 and 33, thereby controlling the switching elements 311, 321 and 331 included in the power conversion circuits 31, 32 and 33 to be ON and OFF.

For example, the carrier frequency corresponding to the power conversion circuit 31 is set to be 15 KHz, the carrier frequency corresponding to the power conversion circuit 32 is set to be 20 KHz, and the carrier frequency of the power conversion circuit 33 is set to be 10 KHz. Thus, since the carrier signals corresponding to the power conversion circuits 31, 32 and 33 have different carrier frequencies, the power conversion circuits 31, 32 and 33 operates with different switching timings (ON-OFF timing) of the switching elements 311, 321 and 331 corresponding to the power conversion circuits 31, 32 and 33. As a result, an amount of the ripple current flowing through the filter circuit 20 (total ripple current) can be reduced, compared to the above-described comparative example.

According to the second embodiment as described above, an operation signal to be transmitted to a specific power conversion circuit 31 among the power conversion circuits 31, 32 and 33 includes a carrier frequency having a frequency range which is different from frequency ranges of the carrier frequencies to be transmitted to the other power conversion circuits 32 and 33. Therefore, as similar to the first embodiment, an amount of the ripple current flowing through the filter circuit 20 can be reduced.

### Third Embodiment

The power conversion apparatus according to the third embodiment is described as follows. In the third embodiment, the operation signals include carrier frequencies which are asynchronous to the clock frequency of the power conversion circuit 31, 32 and 33.

Specifically, carrier signals are generated without synchronizing to the clock signal and the switching timings of the switching elements 311, 321 and 331 included in the power conversion circuits 31, 32 and 33 are controlled to be shifted from each other whereby the carrier frequencies are controlled to be asynchronous. Thus, since the carrier frequencies are controlled to be asynchronous, the power conversion circuits 31, 32 and 33 operate with different switching timings of the switching elements 311, 321 and 331. As a result, an amount of ripple current flowing through the filter circuit 20 (total ripple current) can be reduced compared to the power conversion apparatus in the above-described comparative example.

According to the third embodiment, the operation signal includes carrier frequencies which are asynchronous to the clock frequency of the power conversion circuit 31, 32 and 33, whereby an amount of the ripple current flowing through the filter circuit 20 can be reduced as similar to that of the first embodiment.

### Fourth Embodiment

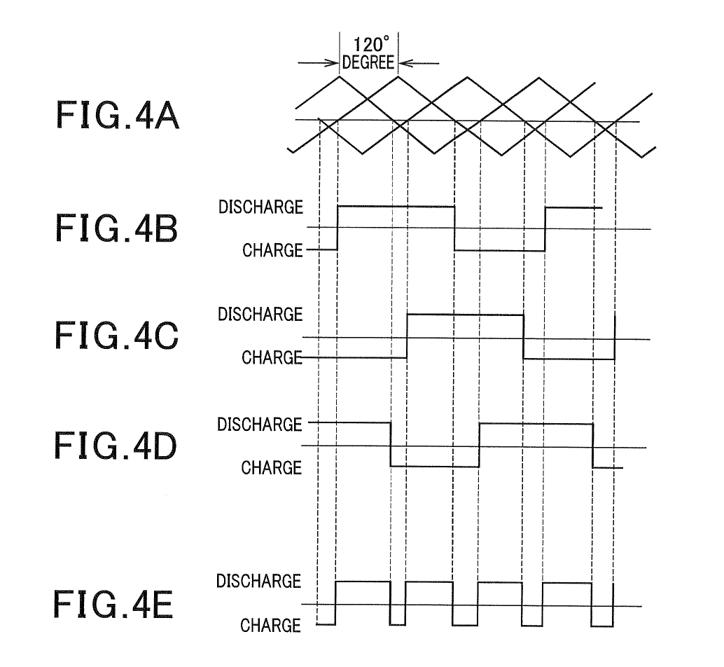

With reference to FIGS. 4A, 4B, 4C, 4D and 4E, the power conversion apparatus according to the fourth embodiment is described as follows. According to the fourth embodiment, the power conversion apparatus converts power based on two phase modulation. The power conversion apparatus controls phases of the carrier signals of the power conversion apparatus to be shifted from each other. As shown in FIG. 4A, the ECU 80 and the control circuit 71, 72 and 73 controls, based on carrier signals of which phases are shifted with a predetermined angle (e.g. 120 degree), the switching timings of the switching elements 311, 321 and 331 included in the power conversion circuits 31, 32 and 33 to be shifted from each other.

It is noted that an amount of the phase-shift is expressed as: 1/(Fc×Nb), where Fc is carrier frequency and Nb is the number of power conversion circuit. According to the fourth embodiment, since the Nb=3, an amount of the phase-shift becomes 1/(3×Fc). When the phase-shift is expressed by using an angle, assuming the carrier period (equivalent to 1/Fc) is 360 degree, an amount of the phase-shift becomes 360×(⅓)=120 degree. In this case, the phase-shift angle includes angles multiplied by 120 degree (excludes 360 degree and its multiplied angles).

According to the above-described control in the fourth embodiment, the power conversion circuits 31, 32 and 33 operates with the switching timings of the switching elements 311, 321 and 331 to be different from each other. The ripple current flowing through the power conversion circuits 31, 32 and 33 are as shown in FIGS. 4B, 4C and 4D, and the ripple current flowing through the filter circuit 20 (total ripple current) is as shown in FIG. 4E.

The fourth embodiment exemplified a control by using the two-phase modulation and the phases of the carrier signals of the power conversion circuits 31, 32 and 33 are shifted from each other as similar to that of the first embodiment. As a result, the ripple current flowing through the filter circuit 20 can be reduced.

### Fifth Embodiment

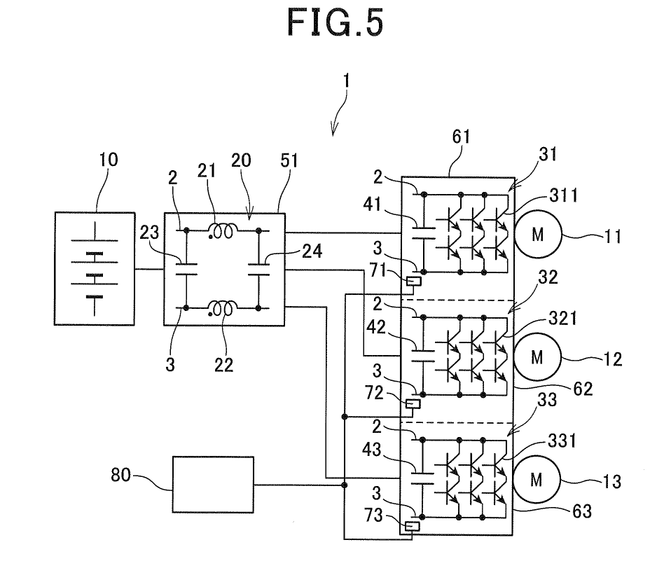

The power conversion apparatus according to the fifth embodiment is as shown in FIG. 5. In the fifth embodiment, the shapes of the second casings 61, 62 and 63 and the disposition thereof are different from that of the first embodiment.

According to the fifth embodiment, the second casings 61, 62 and 63 that accommodate the power conversion circuits 31, 32 and 33 are integrated to a single casing. Hence, circuit components serving as a power conversion function (power conversion circuits 31, 32 and 33) can be integrated to the single casing. The second casings 61, 62 and 63 are mounted to a location which is apart from the motors 11, 12 and 13. For example, the second casings 61, 62 and 63 are mounted to a frame of the DC-DC converter (not shown) that generates stepped-down voltage from the power of the battery 10 and supplies the step-down voltage to the control circuit 71, 72 and 73. It is noted that the first casing 51 that accommodates the filter circuit 20 is disposed in the frame of the DC-DC converter as well as the configuration of the first embodiment.

According to the fifth embodiment as described above, among the three second casings 61, 62 and 63, two or more casings (three casings according to the fifth embodiment) are integrated to form a single casing. As a result, a function used in common (i.e., power conversion function) can be integrated and separated from different function blocks (i.e., filtering function).

### Sixth Embodiment

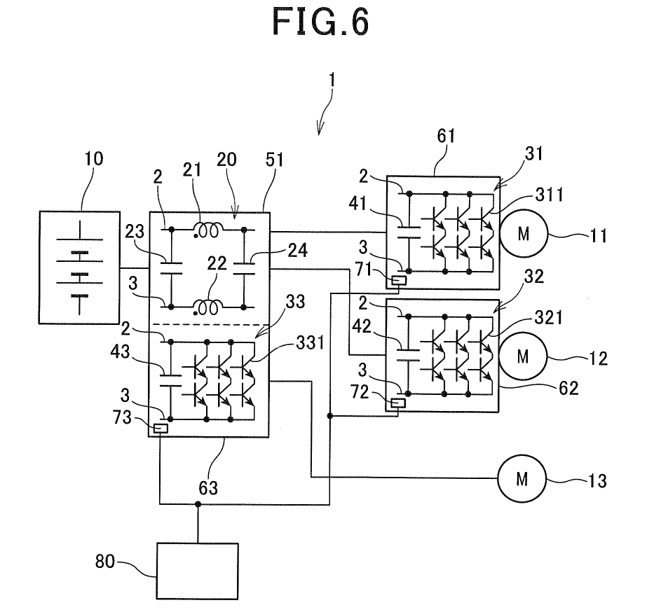

The power conversion apparatus according to the sixth embodiment is as shown in FIG. 6. According to the sixth embodiment, the first casing 51 and the second casings 61, 62 and 63 differs from the casing of the first embodiment in its shape and the disposition.

According to the sixth embodiment, the first casing 51 that accommodates the filter circuit 20 is integrated with the second casing 63 that accommodates the power conversion apparatus 33. The first casing 51 and the second casing 63 which are integrated with each other are disposed in the frame of the DC-DC converter (not shown) that supplies stepped-down voltage of the battery 10 to the control circuits 71, 72 and 73. As similar to the first embodiment, the second casing 61 is mounted on the motor casing of the motor 11, and the second casing 62 is mounted on the motor casing of the motor 12.

According to the sixth embodiment as described above, the first casing 51 is integrated with one or two second casing (the second casing 63 according to the sixth embodiment) which is selected from among the three second casings 61, 62 and 63. In other words, as far as at least one casing among the three second casings 61, 62 and 63 is separated from the first casing 51, the second casing can be integrated to the first casing 51.

### Seventh Embodiment

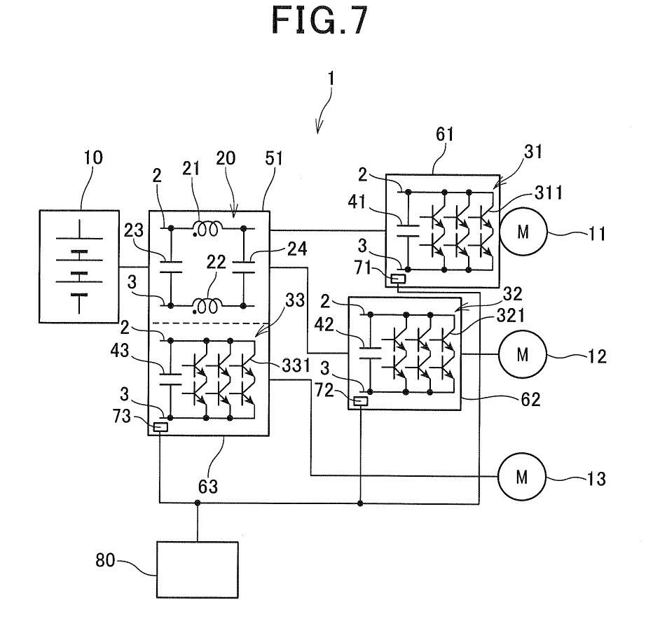

The power conversion apparatus according to the seventh embodiment is as shown in FIG. 7. According to the seventh embodiment, the disposition of the second casing 62 differs from that of the sixth embodiment. In the seventh embodiment, the second casing 62 is disposed to be apart from the motor 12 mounted on the vehicle. Thus, the seventh embodiment exemplifies that each of a plurality of casings serving as a filter function or a power conversion function is disposed at any locations in the vehicle.

### Other Embodiment

The above-described embodiments exemplified a power conversion apparatus provided with three power conversion circuits and three second casings. According to the other embodiments of the present disclosure, each of the power conversion circuits and the second casings may be two or four or more in numbers. Further, according to the fifth embodiment, all (three in number) second casings are formed to be integrated with each other. However, according to the other embodiment, any number of casings selected from a plurality of second casings can be integrated.

According to the sixth embodiment and seventh embodiment, a configuration in which the first casing and a second casing selected from a plurality of second casings are integrated is disclosed. However, according to the other embodiment of the present disclosure, as far as at least one casing among a plurality of second casings is separated from the first casing, the other second casings can be integrated to the first casing. Specifically, the first casing can be integrated with a plurality of second casings. Moreover, according to the other embodiments, the first casing that accommodates the filter circuit can be disposed at any locations other than the DC-DC converter. For example, the first casing can be disposed in a frame of an on-vehicle power conversion unit (i.e., inverter) that is supplied with the power of which voltage is the same as the voltage supplied to the first casing.

According to the above-described embodiments, the control circuits accommodated in the respective second casings and the electronic control unit (ECU) constitute the control unit and the control unit controls the switching timings of the respective power conversion circuits to be different from each other. However, the other embodiments of the present disclosure may not include the ECU, however, only control circuits accommodated in the second casing may constitute the control unit so as to control the switching timings (ON-OFF timing) of the switching elements in the power conversion circuits to be different from each other. In this case, the respective control circuits mutually communicate so as to control the phases of the carrier signals to be shifted from each other, whereby the power conversion circuits may operate with different switching timings of the switching elements. Alternatively, without using the control circuits in the second casing, the power conversion apparatus constitutes the control unit by only using the electronic control unit and may control the switching timings in the power control circuits to be different from each other.

Also, an amount of the phase-shift described in the first embodiment and the fourth embodiment can be changed to any value. Further, values of the carrier frequencies to be transmitted to the respective power conversion circuits which are described in the second embodiment may be changed to any value. Moreover, according to the above-described embodiments, a triangle wave signal is used for the carrier signals. However, in the other embodiments of the present application, various types of signals such as sine-wave signal, pulse signal and saw-tooth signal may be used.

Furthermore, according to the above-described embodiments, a LC filter as a filter circuit is used in the power conversion apparatus. However, in the other embodiments, as a filter circuit, an active circuit or passive circuits such as RLC filter, RC filter can be employed in the power conversion apparatus. Regarding the switching element, it is not limited to the IGBT as a switching element, however, any types of semiconductor elements capable of performing switching-operation, such as FETs (MOS-FET, Junction-FET and Metal-semiconductor FET) can be employed. In the above-described several embodiments, any combined configurations may be employed while there are no difficulties to constitute the combined configurations.

The power conversion apparatus according to the present disclosure is not limited to a blower fan used for an auxiliary unit mounted on the vehicle, a motor used for a water pump, a motor used for a cooling fan, however, the power conversion apparatus according to the present disclosure can be adapted to various equipment capable of operating with a power supplied by the power conversion apparatus, such as, a heater of an on-vehicle air-conditioner, a rotary electric machine, an electrical loads, a power supply unit, a control apparatus, and a measurement equipment. Moreover, the power conversion apparatus according to the present disclosure is not limited to equipment mounted on the vehicle, however, the power conversion apparatus can be adapted to any other equipment other than on-vehicle equipment.

What is claimed is:

1. A power conversion apparatus that converts power transmitted from a power source and supplies a plurality of electrical loads with power converted by the power conversion apparatus, comprising:
a filter circuit including an input circuit and an output circuit, the input circuit being connected to the power source and receiving the power transmitted from the power source;
a plurality of power conversion circuits each having an input circuit and an output circuit, disposed correspondingly to the plurality of electrical loads, every input circuit of the plurality of power conversion circuits being connected in common to the output circuit of the filter circuit to be shared by the plurality of power conversion circuits and receiving the power transmitted from the filter circuit, respective output circuits of the plurality of power conversion circuits being correspondingly connected to the plurality of electrical loads, each of the power conversion circuits converting the power transmitted from the filter circuit and supplying the power converted by each of the power conversion circuits to corresponding electrical loads;
a first casing that accommodates the filter circuit; and
a plurality of second casings disposed correspondingly to the plurality of power conversion circuits, the plurality of second casings each accommodating corresponding power conversion circuit.

2. The power conversion apparatus according to claim 1, wherein the power conversion apparatus includes a control unit that transmits an operation signal to the power conversion circuit thereby controlling the power conversion circuit, and the operation signal operates the respective power conversion circuits such that switching timings in the respective power conversion circuits are different from each other.

3. The power conversion apparatus according to claim 2, wherein the operation signal includes a carrier frequency being asynchronous to a clock frequency used in the power conversion circuit.

4. The power conversion apparatus according to claim 2, wherein an operation signal to be transmitted to a specific power conversion circuit among the plurality of power conversion circuits includes a carrier frequency having a frequency range which is different from frequency ranges of the carrier frequencies to be transmitted to the other power conversion circuits.

5. The power conversion apparatus according to claim 3, wherein an operation signal to be transmitted to a specific power conversion circuit among the plurality of power conversion circuits includes a carrier frequency having a frequency range which is different from frequency ranges of the carrier frequencies to be transmitted to the other power conversion circuits.

6. The power conversion apparatus according to claim 2, wherein the operation signal includes a carrier frequency of a carrier signal that is synchronized to a clock frequency of the control unit, and the control unit controls phases of the carrier signals to be shifted from each other.

7. The power conversion apparatus according to claim 1, wherein the second casing is formed such that two or more casings among the plurality of second casings are integrated to form a single casing.

8. The power conversion apparatus according to claim 1, wherein the first casing is formed to be integrated with a second casing excluding at least one second casing from among the plurality of second casings.
